(19) United States
(12) Patent Application Publication
(10) Pub. No.: US 2020/0130218 A1
(43) Pub. Date: Apr. 30, 2020

(54) Food Processing Machine with Quickly Cutting Function

(71) Applicant: HUNDRED MACHINERY ENTERPRISE CO., LTD., Tainan City (TW)

(72) Inventor: Cheng-Yen Tsai, Tainan City (TW)

(21) Appl. No.: 16/594,129

(22) Filed: Oct. 7, 2019

(30) Foreign Application Priority Data
Oct. 24, 2018 (TW) 107214456

(51) Int. Cl. B26D 7/26; B26D 7/06; B26D 5/02

(52) U.S. Cl. CPC B26D 7/2614; B26D 2210/02; B26D 5/02; B26D 7/0683

(57) ABSTRACT

A food processing machine includes a driving mechanism, a connecting unit connected with the driving mechanism, a linkage connected with the connecting unit, and a cutter unit connected with the linkage. The connecting unit includes a driving lever and a driven handle. The linkage includes a disk, a primary rotation shaft, and a plurality of secondary rotation shafts. The cutter unit includes a plurality of connecting members and a plurality of cutters. Each of the cutters is provided with a first hooked portion and a second hooked portion. The first hooked portion of each of the cutters is to hooked onto the second hooked portion of an adjacent cutter, such that the cutters are drawn mutually by each other, to provide a larger cutting force to cut the elongated food strip when the cutters are retracted inward.

### BACKGROUND OF THE INVENTION

### 1. Field of the Invention

The present invention relates to a processing machine and, more particularly, to a food processing machine for processing a foodstuff.

### 2. Description of the Related Art

A food processing machine is used to process a foodstuff and comprises a cutting and forming device to cut an elongated food strip into multiple food lumps (or pieces) which are used to make stuffed food, such as dumplings, steamed stuffed bun or the like. The conventional cutting and forming device includes a plurality of cutters, and a plurality of linking members connected with the cutters. In use, the cutters are driven by action of the linking members, such that the cutters are expanded outward or retracted inward simultaneously. When the cutters are expanded outward, an opening is formed between the cutters to allow passage of the elongated food strip, and when the cutters are retracted inward, the cutters provide a cutting force to cut the elongated food strip into multiple food lumps. However, there is no connecting mechanism between the cutters to draw the cutters together, such that the cutters are operated individually, thereby decreasing the cutting force of the cutters. Thus, the cutters cannot cut the elongated food strip smoothly.

### BRIEF SUMMARY OF THE INVENTION

The primary objective of the present invention is to provide a food processing machine with a quickly cutting and forming function, to cut a foodstuff quickly.

In accordance with the present invention, there is provided a food processing machine comprising a driving mechanism, a connecting unit connected with the driving mechanism, and a linkage connected with the connecting unit. The connecting unit includes a driving lever connected with the driving mechanism, and a driven handle pivotally connected with the driving lever. The driven handle is provided with a groove mounted on the driving lever. The driven handle of the connecting unit has a bottom provided with a projection. The driving lever is pivotally connected with the groove of the driven handle. The linkage includes a disk, a primary rotation shaft mounted on the disk, and a plurality of secondary rotation shafts mounted on the disk. The disk of the linkage has a periphery provided with a recess corresponding to the projection of the driven handle. The primary rotation shaft of the linkage is secured to the driven handle of the connecting unit. The secondary rotation shafts of the linkage are arranged in an annular shape.

The food processing machine further comprises a cutter unit connected with the linkage. The cutter unit includes a plurality of connecting members secured to the secondary rotation shafts of the linkage respectively, and a plurality of cutters mounted on the connecting members respectively. The cutters are arranged in an annular shape. Each of the cutters is provided with a slot receiving one of the connecting members. The slot extends through each of the cutters. Each of the cutters has a first side provided with a first hooked portion and a concave face, and a second side provided with a second hooked portion and a protruding cutting face. The first hooked portion of each of the cutters is hooked onto the second hooked portion of an adjacent cutter. The concave face of each of the cutters closely presses the cutting face of an adjacent cutter.

According to the primary advantage of the present invention, the driving lever and the driven handle are pivotally connected with each other, and are respectively connected with the slide board of the driving mechanism and the primary rotation shaft of the linkage, such that the driving lever and the driven handle are operated smoothly and conveniently.

According to another advantage of the present invention, the first hooked portion of each of the cutters is hooked onto the second hooked portion of an adjacent cutter, such that the cutters are drawn mutually by each other, to provide a larger cutting force when the cutters are retracted inward, so as to cut the elongated food strip smoothly and steadily.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a food processing machine in accordance with the preferred embodiment of the present invention.

FIG. 2 is a top view of the food processing machine in accordance with the preferred embodiment of the present invention.

FIG. 3 is a perspective view of a cutter unit of the food processing machine in accordance with the preferred embodiment of the present invention.

FIG. 4 is a perspective view of a cutter of the cutter unit as shown in FIG. 3.

### DETAILED DESCRIPTION OF THE INVENTION

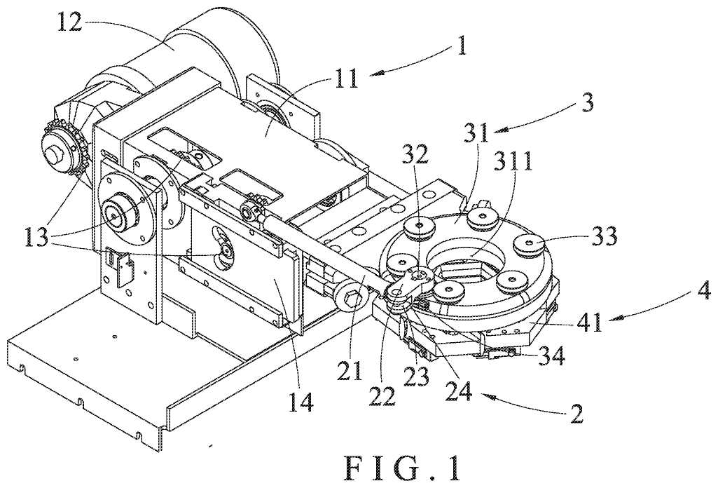

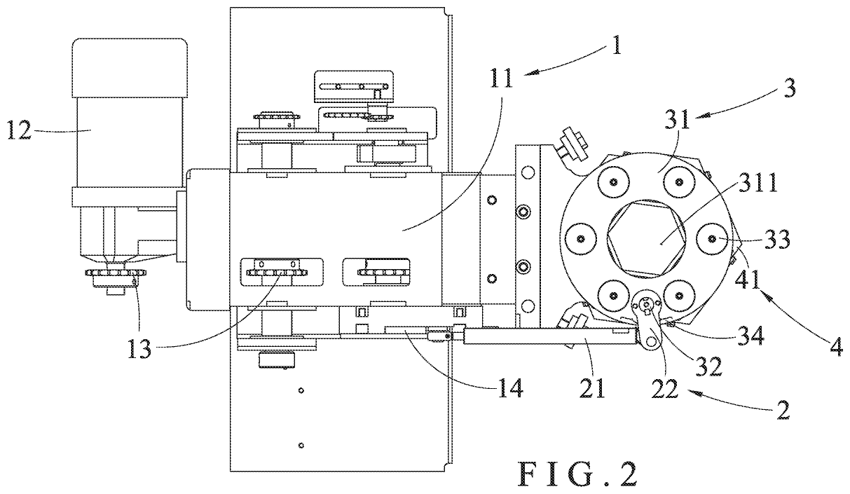

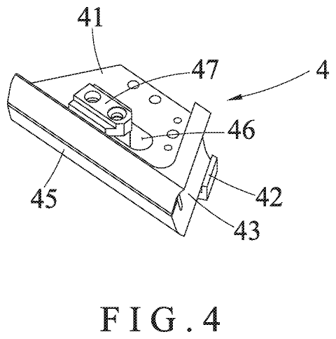

Referring to FIGS. 1-4, a food processing machine in accordance with the preferred embodiment of the present invention comprises a driving mechanism 1, a connecting unit 2 connected with the driving mechanism 1, and a linkage 3 connected with the connecting unit 2.

The connecting unit 2 includes a driving lever 21 connected with the driving mechanism 1, and a driven handle 22 pivotally connected with the driving lever 21. The driven handle 22 is provided with a groove 23 mounted on the driving lever 21. The driven handle 22 of the connecting unit 2 has a bottom provided with a projection 24. The driving lever 21 is pivotally connected with the groove 23 of the driven handle 22.

The linkage 3 includes a disk 31, a primary rotation shaft 32 mounted on the disk 31, and a plurality of secondary rotation shafts 33 mounted on the disk 31. The disk 31 of the linkage 3 has a periphery provided with a recess 34 corresponding to the projection 24 of the driven handle 22. In use, when the driven handle 22 is rotated to a determined position, the projection 24 of the driven handle 22 is moved to rest on the recess 34 of the disk 31, to stop rotation of the driven handle 22, such that the driven handle 22 cannot be pivoted any more. The disk 31 of the linkage 3 has a center provided with a passage 311 which allows passage of an elongated food strip (or dough). The primary rotation shaft 32 of the linkage 3 is secured to the driven handle 22 of the connecting unit 2. The secondary rotation shafts 33 of the linkage 3 are arranged in an annular shape.

In the preferred embodiment of the present invention, the food processing further comprises a cutter unit 4 connected with the linkage 3. The cutter unit 4 includes a plurality of connecting members 47 secured to the secondary rotation shafts 33 of the linkage 3 respectively, and a plurality of cutters 41 mounted on the connecting members 47 respectively. Each of the connecting members 47 has a noncircular shape. The cutters 41 are arranged in an annular shape. Each of the cutters 41 is provided with a slot 46 receiving one of the connecting members 47, such that the cutters 41 are slidable relative to the connecting members 47. The slot 46 has an elongated shape and extends through each of the cutters 41. Each of the cutters 41 has a first side provided with a first hooked portion 42 and a concave face 43, and a second side provided with a second hooked portion 44 and a protruding cutting face 45. The first hooked portion 42 of each of the cutters 41 is hooked onto the second hooked portion 44 of an adjacent cutter 41. The concave face 43 of each of the cutters 41 closely presses the cutting face 45 of an adjacent cutter 41. The cutting face 45 of each of the cutters 41 is parallel with the slot 46.

In the preferred embodiment of the present invention, the driving mechanism 1 includes a platform 11, an actuator 12 mounted on the platform 11, a plurality of transmission members 13 mounted on the platform 11, and a slide board 14 mounted on the platform 11. The transmission members 13 are connected with each other. Two of the transmission members 13 are connected with the actuator 12 and the slide board 14 respectively. In operation, when the actuator 12 is operated, the slide board 14 is driven to slide sideward reciprocatingly by transmission of the transmission members 13. The structure of the driving mechanism 1 was disclosed in the Taiwanese Patent Publication No. M343387, and will not be further described in detail.

In the preferred embodiment of the present invention, the driving lever 21 of the connecting unit 2 is connected with the slide board 14 of the driving mechanism 1.

In the preferred embodiment of the present invention, the driving lever 21 of the connecting unit 2 is connected with the slide board 14 of the driving mechanism 1, and the driven handle 22 of the connecting unit 2 is connected with the primary rotation shaft 32 of the linkage 3, such that the connecting unit 2 is connected between the slide board 14 of the driving mechanism 1 and the primary rotation shaft 32 of the linkage 3. Thus, the slide board 14 of the driving mechanism 1 slides reciprocatingly, the primary rotation shaft 32 of the linkage 3 is also driven to rotate reciprocatingly.

The disk 31 of the linkage 3 is provided with a plurality of linking members connected with each other. The linking members of the linkage 3 are connected with the primary rotation shaft 32 and the secondary rotation shafts 33 respectively. Thus, when the primary rotation shaft 32 is rotated, the linking members are driven to drive the secondary rotation shafts 33, such that the secondary rotation shafts 33 are rotated simultaneously. The linking members of the linkage 3 includes gears and annular gears. The gears of the linking members are coaxially connected with the primary rotation shaft 32 and the secondary rotation shafts 33, and mesh with the annular gears. Thus, when the primary rotation shaft 32 is rotated, the secondary rotation shafts 33 are rotated simultaneously. The structure of the primary rotation shaft 32, the secondary rotation shafts 33, and the linking members was disclosed in the Taiwanese Patent Publication No. M542358, and will not be further described in detail.

In operation, the driving mechanism 1 drives the slide board 14 which drives the driving lever 21 which drives the driven handle 22 which drives the primary rotation shaft 32 which drives the secondary rotation shafts 33 which drive the connecting members 47. In such a manner, when the primary rotation shaft 32 is rotated, the secondary rotation shafts 33 and the connecting members 47 are rotated simultaneously. At this time, each of the connecting members 47 is received in the slot 46 of each of the cutters 41 and has a noncircular shape, such that the connecting members 47 drive the cutters 41 to rotate therewith. In addition, the first hooked portion 42 of each of the cutters 41 is hooked onto the second hooked portion 44 of an adjacent cutter 41, and the concave face 43 of each of the cutters 41 closely presses the cutting face 45 of an adjacent cutter 41, such that the cutters 41 slide relative to the connecting members 47 respectively. Thus, the cutters 41 rotate and slide simultaneously, such that the cutters 41 extend outward or retract inward simultaneously.

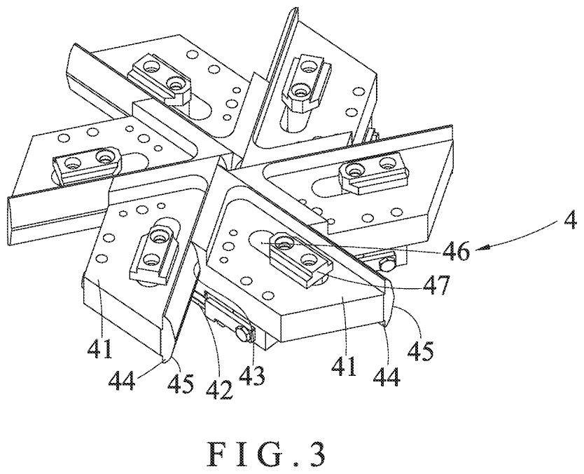

Referring to FIG. 3, when the connecting members 47 drive the cutters 41 to rotate anticlockwise, the first hooked portion 42 is hooked onto the second hooked portion 44, and the concave face 43 closely presses the cutting face 45, such that the cutters 41 are pushed by the connecting members 47 to move outward. In such a manner, the cutters 41 are expanded outward to form an opening between the cutters 41. Thus, the elongated food strip is delivered to pass through the passage 311 of the disk 31 and through the opening between the cutters 41.

When the connecting members 47 drive the cutters 41 to rotate clockwise, the first hooked portion 42 is hooked onto the second hooked portion 44, such that the cutters 41 are pulled by the connecting members 47 to move inward. In such a manner, the cutters 41 are retracted inward, and the cutting face 45 of each of the cutters 41 is moved to cut the elongated food strip. Thus, when the cutters 41 are expanded outward and retracted inward reciprocatingly, the elongated food strip is cut and formed into multiple granular or roundish food lumps (or sections or pieces) which are used to make stuffed food, such as dumplings, steamed stuffed bun or the like. At this time, the first hooked portion 42 is hooked onto the second hooked portion 44, such that the cutters 41 are drawn by each other, to provide a larger cutting force on the elongated food strip, so as to cut the elongated food strip smoothly and steadily.

Accordingly, the driving lever 21 and the driven handle 22 are pivotally connected with each other, and are respectively connected with the slide board 14 of the driving mechanism 1 and the primary rotation shaft 32 of the linkage 3, such that the driving lever 21 and the driven handle 22 are operated smoothly and conveniently. In addition, the first hooked portion 42 of each of the cutters 41 is hooked onto the second hooked portion 44 of an adjacent cutter 41, such that the cutters 41 are drawn mutually by each other, to provide a larger cutting force when the cutters 41 are retracted inward, so as to cut the elongated food strip smoothly and steadily.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A food processing machine comprising:
a driving mechanism;
a connecting unit connected with the driving mechanism; and
a linkage connected with the connecting unit;
wherein:
the connecting unit includes a driving lever connected with the driving mechanism, and a driven handle pivotally connected with the driving lever;
the driven handle is provided with a groove mounted on the driving lever;
the driven handle of the connecting unit has a bottom provided with a projection;
the driving lever is pivotally connected with the groove of the driven handle;
the linkage includes a disk, a primary rotation shaft mounted on the disk, and a plurality of secondary rotation shafts mounted on the disk;
the disk of the linkage has a periphery provided with a recess corresponding to the projection of the driven handle;
the primary rotation shaft of the linkage is secured to the driven handle of the connecting unit; and
the secondary rotation shafts of the linkage are arranged in an annular shape.

2. The food processing machine of claim 1, further comprising:
a cutter unit connected with the linkage;
wherein:
the cutter unit includes a plurality of connecting members secured to the secondary rotation shafts of the linkage respectively, and a plurality of cutters mounted on the connecting members respectively;
the cutters are arranged in an annular shape;
each of the cutters is provided with a slot receiving one of the connecting members;
the slot extends through each of the cutters;
each of the cutters has a first side provided with a first hooked portion and a concave face, and a second side provided with a second hooked portion and a protruding cutting face;
the first hooked portion of each of the cutters is hooked onto the second hooked portion of an adjacent cutter; and
the concave face of each of the cutters closely presses the cutting face of an adjacent cutter.
